(19) United States
(12) Patent Application Publication
(10) Pub. No.: US 2025/0323727 A1
(43) Pub. Date: Oct. 16, 2025

(54) Optical Signal Processing Device and Optical Signal Transmission System

(71) Applicant: Nippon Telegraph and Telephone Corporation, Tokyo (JP)

(72) Inventors: Kenya Suzuki, Musashino-shi, Tokyo (JP); Ai Yanagihara, Musashino-shi, Tokyo (JP); Yoshie Morimoto, Musashino-shi, Tokyo (JP)

(21) Appl. No.: 18/866,420

(22) PCT Filed: May 18, 2022
(86) PCT No.: PCT/JP2022/020727

§ 371 Date: Nov. 15, 2024

(51) Int. Cl. H04B 10/2519; H04B 10/40

(52) U.S. Cl. CPC H04B 10/2519; H04B 10/40

(57) ABSTRACT

Provided is an optical signal processing apparatus capable of reducing an influence of wavelength dispersion in wavelength division multiplexing communication. An optical signal processing apparatus of the present disclosure includes: an input waveguide that inputs a wavelength multiplexed signal; an optical branching waveguide configured to branch the wavelength multiplexed signal from the input waveguide into a plurality of arm waveguides; a plurality of wavelength selection waveguides connected to the plurality of arm waveguides, each of the plurality of wavelength selection waveguides being configured to select an optical signal from among the branched wavelength multiplexed signals; and an optical merging waveguide configured to merge light from the plurality of arm waveguides.

### TECHNICAL FIELD

The present invention relates to an optical signal processing apparatus and an optical signal transmission system used for an optical communication network.

### BACKGROUND ART

Due to the explosive spread of data communication networks such as the Internet, a demand for increasing a capacity of optical communication networks is increasing more and more. Wavelength division multiplexing (WDM) communication has been put into practical use to meet such demand for optical communication networks. In particular, also in Ethernet (registered trademark) which is a short-distance communication standard, an optical technology is applied for extension, and WDM signals of about four waves are further applied. A transceiver in the optical Ethernet thus includes a wavelength multiplexer/demultiplexer that multiplexes and demultiplexes WDM signals of about four waves. In order to miniaturize the transceiver, a wavelength multiplexer/demultiplexer in which a plurality of dielectric multilayer films having different wavelength transmission characteristics is mounted or a transceiver using an arrayed waveguide grating formed on an optical waveguide substrate has been put into practical use so far.

FIG. 1 is a diagram illustrating a configuration example of a general small-sized transceiver. A transceiver 10 illustrated in FIG. 1 is used for a transceiver on a reception side. The transceiver 10 includes an optical waveguide substrate 11 on which a single-mode input waveguide 13, an arrayed waveguide grating 12, and a multi-mode four-channel output waveguide 14 are formed, a four-channel photodetector (PD) array 18, a lens 15 that couples an optical signal to the input waveguide 13, and a microlens array (gradient index (GRIN) lens) 16 that couples an optical signal from the four-channel output waveguide 14 to the four-channel PD array 18. The four-channel PD array 18 is mounted on a ceramic carrier 17 on which wiring 19 is formed. An interval between the four-channel PD array 18 and the microlens array 16 is maintained by a spacer 20. As illustrated in FIG. 1, an optical signal input to the arrayed waveguide grating 12 is demultiplexed into four wave optical signals by the arrayed waveguide, and input to the four-channel PD array 18.

### CITATION LIST

### Non Patent Literature

Non Patent Literature 1: Y. Doi, M. Oguma, M. Ito, I. Ogawa, T. Yoshimatsu, T. Ohno, E. Yoshida, H. Takahashi, “Compact ROSA for 100-Gb/s (4×25 Gb/s) Ethernet with a PLC-based AWG demultiplexer,” 2013 Optical Fiber Communication Conference and Exposition and the National Fiber Optic Engineers Conference (OFC/NFOEC)

### SUMMARY OF INVENTION

On the other hand, in the optical Ethernet, in order to avoid waveform distortion due to wavelength dispersion of an optical fiber, a communication wavelength has been set to a 1.3 μm band which is a zero dispersion wavelength of a single-mode optical fiber. However, as a capacity increases, a baud rate of a signal increases, and distortion of an optical signal cannot be ignored even at 1.3 μm.

FIG. 2 is a diagram illustrating a wavelength and wavelength dispersion in a general single-mode optical fiber. A relationship between a wavelength λ and a wavelength dispersion coefficient D is expressed by Equations 1-1 and 1-2. λ₀ₘᵢₙ is a minimum zero dispersion wavelength, λ₀ₘₐₓ is a maximum zero dispersion wavelength, S₀ₘᵢₙ is a minimum zero dispersion slope, and S₀ₘₐₓ is a maximum zero dispersion slope.

$$\begin{matrix}[ Math . 1 ‐ 1 ] & \\ \frac{λ {S}_{0 max}}{4} [ 1 - {( \frac{{λ}_{0 min}}{λ} )}^{4} ] \leq D ( λ ) ( {λ}_{0 min} \leq λ \leq {λ}_{0 max} ) & ( Equation 1 ‐ 1 )\end{matrix}$$

$$\begin{matrix}[ Math . 1 ‐ 2 ] & \\ D ( λ ) \leq \frac{λ {S}_{0 min}}{4} [ 1 - {( \frac{{λ}_{0 min}}{λ} )}^{4} ] ( λ \leq {λ}_{0 min} ) & ( Equation 1 ‐ 2 )\end{matrix}$$

In FIG. 2, four vertical lines are grid wavelengths standardized in a WDM standard in the optical Ethernet (LAN-WDM: 800 GHz interval (about 4 nm interval)). As illustrated in FIG. 2, as the zero dispersion wavelength is changed from 1.31 μm to a shorter wavelength, an absolute value of wavelength dispersion becomes larger, and waveform distortion cannot be ignored. It is desirable to reduce an influence of wavelength dispersion in wavelength division multiplexing communication in the Ethernet.

The present disclosure has been made in view of such a problem, and an object thereof is to reduce an influence of wavelength dispersion in wavelength division multiplexing communication.

An optical signal processing apparatus according to an embodiment of the present invention includes: an input waveguide that inputs a wavelength multiplexed signal; an optical branching waveguide configured to branch the wavelength multiplexed signal from the input waveguide into a plurality of arm waveguides; a plurality of wavelength selection waveguides connected to the plurality of arm waveguides, each of the plurality of wavelength selection waveguides being configured to select an optical signal from among the branched wavelength multiplexed signals; and an optical merging waveguide configured to merge light from the plurality of arm waveguides.

According to this configuration, it is possible to reduce an influence of wavelength dispersion in wavelength division multiplexing communication.

### BRIEF DESCRIPTION OF DRAWINGS

FIG. 1 is a diagram illustrating a configuration example of a general small-sized transceiver.

FIG. 2 is a diagram illustrating a wavelength and wavelength dispersion in a general single-mode optical fiber.

FIG. 3A is a diagram illustrating a schematic configuration of an optical signal processing apparatus according to an embodiment of the present disclosure.

FIG. 3B is a diagram illustrating a schematic configuration of a modification of the optical signal processing apparatus of FIG. 3A.

FIG. 4 is a diagram illustrating a schematic configuration of a wavelength selection waveguide in an optical signal processing apparatus referred to as a unit block in the present disclosure.

FIG. 5 is a diagram for explaining a method for determining widths of a wavelength selection waveguide in an optical signal processing apparatus in the present disclosure.

FIG. 6 is a graph illustrating distributions of the widths of the wavelength selection waveguide in the optical signal processing apparatus of the present disclosure.

7 is a diagram for explaining dispersion amounts applied to a multiplexing filter on a transmission side and a demultiplexing filter on a reception side of an optical signal transmission system according to an embodiment of the present disclosure.

FIG. 8(a) is a diagram illustrating a transmission spectrum and a reflection spectrum of an optical signal processing apparatus in a transceiver on a transmission side according to the embodiment, and FIG. 8(b) is a diagram illustrating a transmission spectrum and a reflection spectrum of the optical signal processing apparatus in the transceiver on a reception side according to the embodiment.

FIGS. 9(a) and 9(b) are diagrams each illustrating a schematic configuration of an optical signal processing apparatus according to an embodiment of the present disclosure.

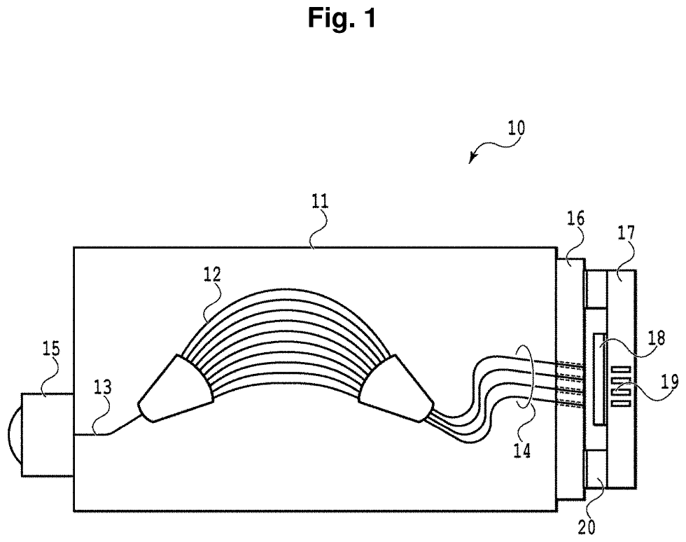

### DESCRIPTION OF EMBODIMENTS

Hereinafter, embodiments of an optical signal processing apparatus of the present disclosure will be described with reference to the drawings. The same or similar reference numerals denote the same or similar components, and repetitive explanation of them will not be made in some cases. Numerical values in the following description are examples, and the optical signal processing apparatus of the present disclosure can be implemented by other numerical values without departing from the gist.

Hereinafter, an embodiment of the present disclosure will be described on the assumption that a transceiver on a reception side separates and receives four optical signals having wavelengths λ0, λ1, λ2, and λ3 from a wavelength multiplexing (WDM) signal transmitted by a transceiver on a transmission side via an optical fiber.

### Embodiment 1

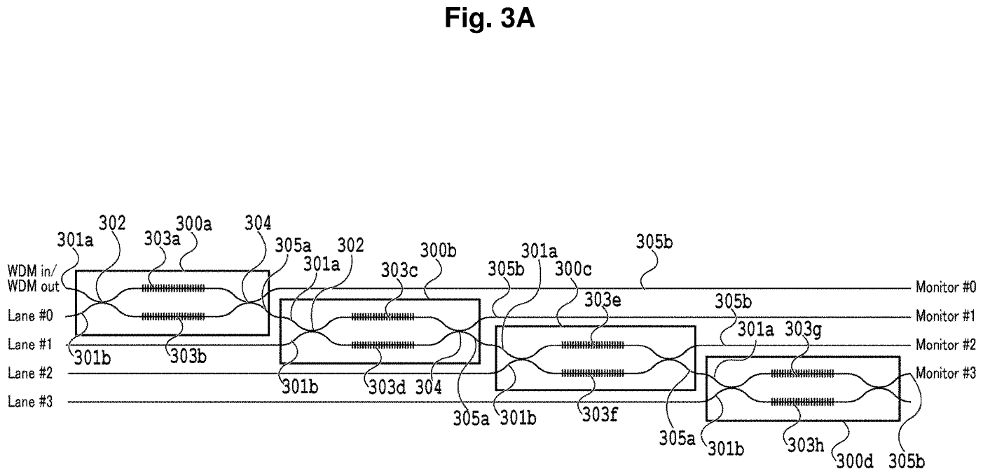

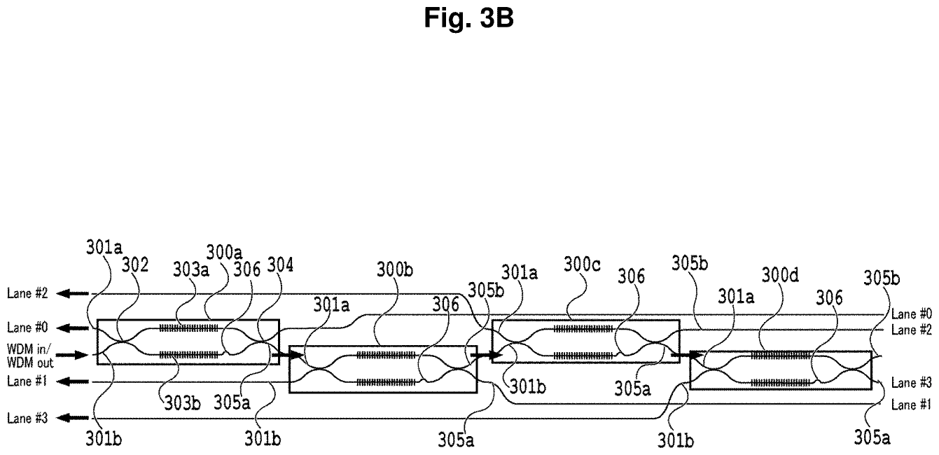

An optical signal processing apparatus according to an embodiment of the present disclosure will be described with reference to FIG. 3A. FIG. 3A is a diagram illustrating a schematic configuration of the optical signal processing apparatus according to the embodiment of the present disclosure. In the present embodiment, an optical signal processing apparatus that operates as a wavelength demultiplexer (demultiplexing filter) in a transceiver on a reception side will be described. However, it is also possible to operate as a wavelength multiplexer (multiplexing filter) in a transceiver on a transmission side by propagating an optical signal in a direction opposite to the following description.

Although the optical signal processing apparatus illustrated in FIG. 3A has a configuration in which four optical signal processing apparatuses 300a, 300b, 300c, and 300d are connected in columns, it can be configured by a single optical signal processing apparatus instead of the configuration in which the optical signal processing apparatuses are connected in columns.

The optical signal processing apparatus 300a includes an input waveguide 301a, a first optical branching/merging waveguide 302 that branches light into a plurality of arm waveguides, a plurality of wavelength selection waveguides 303a and 303b connected to the plurality of arm waveguides, and a second optical branching/merging waveguide 304 configured to merge light. In addition, the optical signal processing apparatus 300a includes an output waveguide 301b connected to the first optical branching/merging waveguide 302 and output waveguides 305a and 305b connected to the second optical branching/merging waveguide 304. A configuration of the wavelength selection waveguide 303 will be described later.

The optical signal processing apparatus 300a includes an input waveguide 301a that inputs a wavelength multiplexing (WDM) signal.

The first optical branching/merging waveguide 302 is configured to branch the WDM signal from the input waveguide 301a into the plurality of arm waveguides. In addition, the first optical branching/merging waveguide 302 is configured to merge light from the plurality of arm waveguides and couple the light to the output waveguide 301b. In the present embodiment, a case of two arm waveguides will be described, but the number of arm waveguides can be three or more.

Each of the two wavelength selection waveguides 303a and 303b is configured to select an optical signal from among the branched WDM signals. The wavelength selection waveguides 303a and 303b selectively reflect a specific wavelength λ0 of WDM wavelengths, and transmit the rest of the WDM signals (wavelengths λ1, λ2, and λ3). Details of configurations of the wavelength selection waveguides 303a and 303b will be described later.

The second optical branching/merging waveguide 304 is configured to merge light from the wavelength selection waveguides 303a and 303b and couple the light to the output waveguides 305a and 305b. Further, the second optical branching/merging waveguide 304 is configured to branch light from the output waveguides 305a and 305b and couple the light to the wavelength selection waveguides 303a and 303b.

The first optical branching/merging waveguide 302 and the second optical branching/merging waveguide 304 can be, for example, a 2×2 directional coupler, a 2×2 multimode interference (MMI) coupler, or a 2×2 crossing waveguide formed on an optical waveguide substrate having two input ports and two output ports with a branching ratio of 50%. The two arm waveguides connecting the first optical branching/merging waveguide 302 and the second optical branching/merging waveguide 304 have equal lengths. As a result, according to a general characteristic of a Mach-Zehnder interferometer-type waveguide circuit, phase states of the two optical signals having the wavelengths λ0 reflected by the wavelength selection waveguides 303a and 303b are coupled to the output waveguide 301b in the first optical branching/merging waveguide 302. In addition, phase states of the two optical signals having the wavelengths λ1, λ2, and λ3 transmitted t the wavelength selection waveguides 303a and 303b are coupled to the output waveguide 305a in the second optical branching/merging waveguide 304. However, depending on wavelength dependency and a manufacturing error of the optical branching/merging waveguide, light from the two arm waveguides may merge and be coupled to the input waveguide 301a. Therefore, an isolator (not illustrated) may be disposed in the input waveguide 301a in order to prevent propagation toward the transceiver on the transmission side. Note that the number of input ports and the number of output ports are not limited to two, and may be three or more. For example, the first optical branching/merging waveguide 302 can be configured by using a 3×3 directional coupler, a WDM signal input from one of the three input ports can be branched into three arm waveguides connected to the three output ports, and three optical signals of wavelengths λ0 reflected by the three wavelength selection waveguides can be coupled to one or two of remaining input ports of the three input ports.

In FIG. 3A, the WDM signal input from the input waveguide 301a described as WDM in/WDM out is branched into two by the first optical branching/merging waveguide 302 and then propagated to the wavelength selection waveguides 303a and 303b. The optical signal having the wavelength λ0 reflected by the wavelength selection waveguides 303a and 303b propagates to the first optical branching/merging waveguide 302 and is coupled to the output waveguide 301b described as Lane #0. Further, the optical signal having the wavelength λ0 is received by a PD (not illustrated) disposed ahead of the output waveguide 301b. On the other hand, the rest of the WDM signals (wavelengths λ1, λ2, and λ3) transmitted through the wavelength selection waveguides 303a and 303b propagate to the second optical branching/merging waveguide 304 and are coupled to the output waveguide 305b.

The optical signal processing apparatus illustrated in FIG. 3A has a configuration in which the above-described optical signal processing apparatus 300a is used as a unit block and a plurality of unit blocks is connected in columns. That is, in the optical signal processing apparatus illustrated in FIG. 3A, the output waveguide 305a of the first unit block 300a is connected to an input waveguide 301a of the second unit block 300b, an output waveguide 305a of the second unit block 300b is connected to an input waveguide 301a of the third unit block 300c, and an output waveguide 305a of the third unit block 300c is connected to an input waveguide 301a of the fourth unit block 300d. Here, the wavelength selection waveguides 303a and 303b, 303c and 303d, 303e and 303f, and 303g and 303h in the unit blocks 300a to 300d are configured to select different wavelengths.

Specifically, the wavelength selection waveguides 303c and 303d are configured to selectively reflect a specific wavelength λ1, the wavelength selection waveguides 303e and 303f are configured to selectively reflect a specific wavelength λ2, and the wavelength selection waveguides 303g and 303h are configured to selectively reflect a specific wavelength λ3 of the WDM wavelengths.

As a result, the optical signal processing apparatus illustrated in FIG. 3A functions as a multiplexing filter that selectively separates optical signals of different wavelengths included in the WDM wavelengths input from the input waveguide 301a of the first input block into Lanes #0, 1, 2, and 3.

Note that, as described above, in a case where the optical signal processing apparatus in FIG. 3A is operated as the multiplexing filter of the transceiver on the transmission side, optical signals having wavelengths λ0, λ1, λ2, and λ3 may be input from Lanes #0, 1, 2, and 3 and output from the input waveguide 301a described as WDM in/WDM out. In this case, the optical signals of the input wavelengths are not completely reflected due to a manufacturing error of the wavelength selection waveguides 303a and 303b, and the output waveguides 305b can be used as monitor ports by coupling to the output waveguides 305b described as Monitors #0, 1, 2, and 3. Although the configuration in which the four unit blocks corresponding to four Lanes are connected in columns has been described, the number of Lanes and unit blocks may be four or more.

### (Modification)

As described above, in the unit block 300 having the configuration the Mach-Zehnder interferometer-type waveguide circuit, the optical signal input from the input waveguide 301a propagates through the arm waveguides, then merges, and propagates to the output waveguide 305a on a cross port side with respect to the input waveguide 301a.

In general, the Mach-Zehnder interferometer-type waveguide circuit has a characteristic that the output waveguide 305b on a bar port side has a small loss and the output waveguide 305a on the cross port side has a large loss with respect to the input waveguide 301a. It is known that, when a branching ratio or a coupling rate of a branching/merging circuit constituting a Mach-Zehnder interferometer deviates from 50%, a loss occurs in the output waveguide 305a on the cross port side, and an extinction ratio deteriorates in the output waveguide 305b on the bar port side.

Therefore, in the configuration of the optical signal processing apparatus of FIG. 3A, the optical signal having the wavelength λ3 of the WDM signals input from the input waveguide 301a of the optical signal processing apparatus 300a passes through the cross port three times before being output from the output waveguide 301b described as Lane #3, and a loss increases.

A modification of the optical signal processing apparatus according to the embodiment of the present disclosure will be described with reference to FIG. 3B. The optical signal processing apparatus illustrated in FIG. 3B is configured to solve the problem of loss increase.

The optical signal processing apparatus illustrated in FIG. 3B is different from the optical signal processing apparatus illustrated in FIG. 3A in that, in each of the unit blocks 300a to 300d, one of the two arm waveguides connecting the first optical branching/merging waveguide 302 and the second optical branching/merging waveguide 304 includes an optical path length adjusting waveguide 306 that adjusts an optical path length of propagating light between the wavelength selection waveguide 303a or 303b and the second optical branching/merging waveguide 304. In addition, the optical signal processing apparatus illustrated in FIG. 3B is different from the optical signal processing apparatus illustrated in FIG. 3A in that the output waveguide 305b of the second unit block 300b is connected to the output waveguide 301b of the third unit block 300c. Furthermore, the optical signal processing apparatus is different from the optical signal processing apparatus illustrated in FIG. 3A in that a WDM signal is input from the output waveguide 301b of the first unit block 300a, an optical signal of λ0 is output from the input waveguide 301a (Lane #0) of the first unit block 300a, an optical signal of λ2 is output from the input waveguide 301a (Lane #2) of the third unit block 300c, and the output waveguides 305a of the second unit block 300b and the fourth unit block 300d can be used as monitor ports of Lanes #2 and #3, respectively.

In FIG. 3B, since lengths of arms between the first optical branching/merging waveguide 302 and the wavelength selection waveguides 303a and 303b are set to be the same, the reflected optical signal of λ0 is output to Lane #0. On the other hand, the optical path length adjusting waveguide 306 is installed in one of the two arm waveguides such that the remaining WDM signals (λ1, λ2, and λ3) transmitted through the wavelength selection waveguides 303a and 303b are output to the bar port (output waveguide 305a) of the Mach-Zehnder interferometer. Similarly, optical path length adjusting waveguides are installed in the second, third, and fourth unit blocks 300b, 300c, and 300d. As a result, optical signals of the wavelengths λ1 to λ4 are output to the cross port of the unit block only once before the optical signals are output to Lanes #0 to #3 on the left side of FIG. 3B. That is, according to the configuration of FIG. 3B, it is possible to configure an optical signal processing apparatus with a small loss.

### Embodiment 2

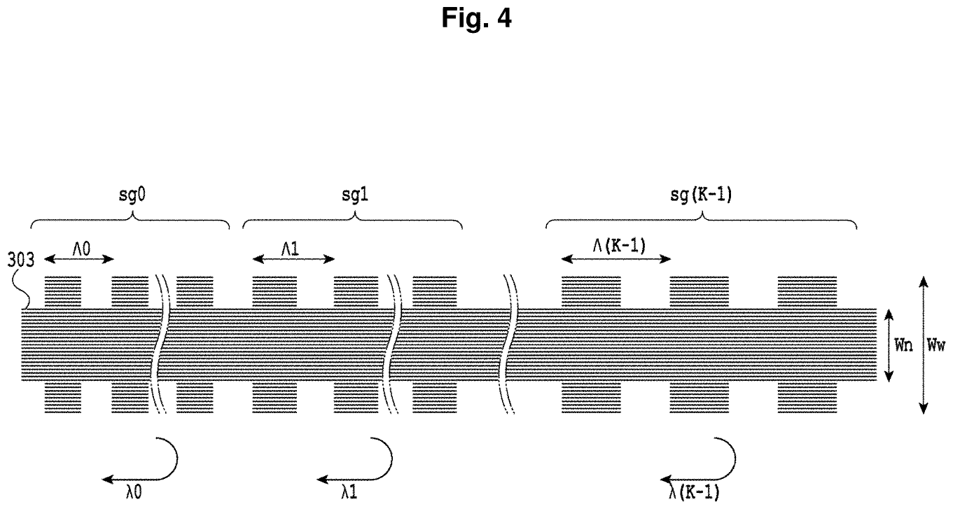

An optical signal processing apparatus according to an embodiment of the present disclosure will be described with reference to FIG. 4. FIG. 4 is a diagram illustrating a schematic configuration of a wavelength selection waveguide 303 in the optical signal processing apparatus 300 referred to as a unit block in FIGS. 3A and 3B. The description overlapping with the above description will be omitted.

In FIG. 4, the wavelength selection waveguide 303 is a waveguide whose width changes in a propagation direction of light at a plurality of periods, and constitutes a Bragg grating. As illustrated in FIG. 4, the wavelength selection waveguide 303 includes (K−1) (K is an integer of 1 or more) regions sg. In each region sgi (i=0 to K−1), a waveguide having a width alternately changed between Wn and Ww in a period of a period Λi (i=0 to K−1) constitutes a Bragg grating. The period Λi in the region sgi gradually changes and gradually becomes longer according to the propagation direction of light. That is, it has a configuration of a chirped Bragg grating (CBG) as a whole.

Among WDM signals (wavelengths λ0, λ1, . . . , and λ(K−1)) input from the left side in FIG. 4, in a region sg0, only an optical signal having a wavelength represented by a Bragg wavelength λ0=2n_{eff}×Λ₀ is reflected with n_{eff} as a transmission refractive index of the Bragg grating, and other wavelengths are transmitted. Subsequently, among the rest of the WDM signals (wavelengths λ1, λ2, . . . , and λ(K−1)) transmitted through the region sg0, in a region sg1, only an optical signal having a wavelength represented by λ1=2n_{eff}×Λ₁ is reflected, and other wavelengths are transmitted. Similarly, among the rest of the WDM signal (wavelength λ(K−1)) transmitted through a region sg(K−2), in a region sg(K−1), only an optical signal having a wavelength represented by λ_{(K-1)}=2n_{eff}×Λ_{(K-1)} is reflected, and other wavelengths are transmitted. By connecting Bragg gratings having different periods in this manner and continuously changing the grating period λi, an optical signal having a specific wavelength among the WDM wavelength signals can be selectively reflected in a rectangular shape.

Furthermore, a position in the propagation direction of the light in which the optical signal is reflected in each region sg (i=0 to K−1) varies depending on the wavelength λi. Therefore, a delay occurs over time between the optical signals reflected at different positions. That is, since a phase of the reflected optical signal changes depending on the wavelength, the wavelength selection waveguide 303 can apply a group delay to the reflected optical signal. A group delay amount can be changed by changing a distance from the region sg0 to the region sg (K−1).

Since a change from the period Λ0 to Λ(K−1) does not need to be linear and any distribution can be given, a group delay of any spectral shape can be given.

Since Bragg grating by an optical fiber is manufactured using irradiation of UV light and interference thereof, it is difficult to change a period in a longitudinal direction. On the other hand, since the wavelength selection waveguide 303 of the present disclosure sets the period A by photolithography, there is an advantage that degree of freedom in setting a group delay spectrum is high. Here, each of the regions sg0 to sg (K-1) is described to include a plurality of periodic structures, but the number of periodic structures may be one. In addition, a width Wn of a thin portion and a width Ww of a thick portion of the wavelength selection waveguide 303 may be set to gradually change.

### Embodiment 3

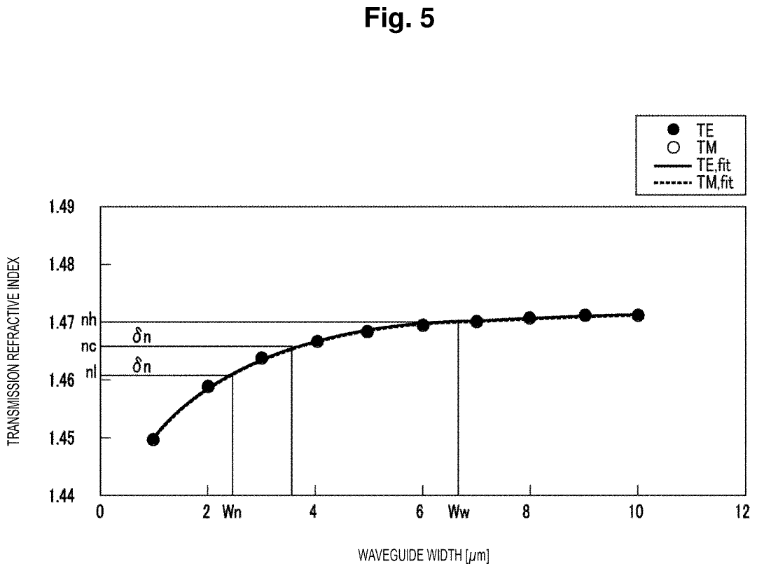

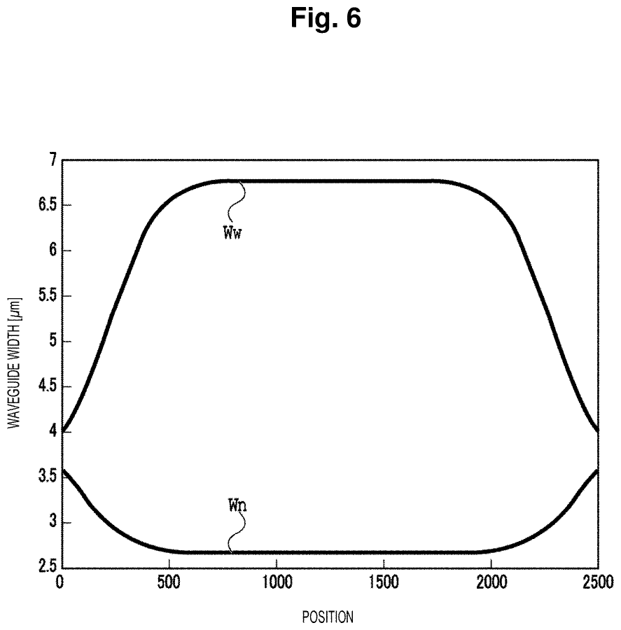

With reference to FIGS. 5 and 6, a schematic configuration of a wavelength selection waveguide 303 in an optical signal processing apparatus 300 according to an embodiment of the present disclosure will be described. FIG. 5 is a diagram for explaining a method of determining waveguide widths. FIG. 6 is a graph illustrating distributions of the widths in an entire Bragg grating.

In general, a Bragg grating has spectral characteristics of a Fourier transform of a spatial distribution of a grating. Therefore, the Bragg grating in which the widths Wn and Ww of the wavelength selection waveguide 303 illustrated in FIG. 4 are simply interchanged with each other has a problem that side lobes are generated in a demultiplexed spectrum.

Apodization is effective for this solution. In the optical fiber Bragg grating, the apodization is automatically performed according to a distribution of irradiated UV light, whereas in the Bragg grating by the waveguide, it is necessary to perform the apodization by controlling the width of the waveguide.

Furthermore, the transmission refractive index n_{eff} of the Bragg grating needs to be constant in the longitudinal direction.

FIG. 5 is a diagram illustrating a relationship between a width w of a waveguide and a transmission refractive index n_{eff} in a quartz-based optical waveguide. The transmission refractive index n_{eff} can be expressed by an approximate equation of Equation 2. n_{Max}, n_{Min}, and w₀ are constants obtained experimentally or by numerical calculation.

$$\begin{matrix}[ Math . 2 ] & \\ {n}_{eff} = ( {n}_{Max} - {n}_{Min} ) [ 1 - {e}^{- w / {w}_{0}} ] + {n}_{Min} & ( Equation 2 )\end{matrix}$$

In FIG. 5, a relative refractive index difference of the waveguide is 2%. First, a central average transmission refractive index nc is set. Next, a refractive index variation on induced by modulating the waveguide width is set, and the maximum refractive index nh=nc+δn and the minimum refractive index nl=nc−δn are determined. δn affects a bandwidth and a reflectance of a Bragg wavelength, and larger on is preferable. Finally, waveguide widths Wn and Ww giving the maximum refractive index nh and the minimum refractive index nl are determined from FIG. 5.

In order to set the apodization, δn is gradually increased in first and last regions of an entire region constituting the Bragg grating in the above description. That is, a change in refractive index increases from an end toward a central region in the first region, and the change in refractive index decreases from the central region toward an end in the last region (by setting the apodization), thereby suppressing side lobes. FIG. 6 is a graph illustrating distributions of the widths in the entire Bragg grating.

### Embodiment 4

An optical signal transmission system according to an embodiment of the present disclosure will be described with reference to FIG. 7. The optical signal transmission system of the present embodiment is a system in which a transceiver (Tx) on a transmission side including the above-described optical signal processing apparatus as a wavelength multiplexer and a transceiver (Rx) on a reception side including the optical signal processing apparatus as a wavelength demultiplexer are connected by an optical fiber. Hereinafter, a design example of a Bragg grating in each optical signal processing apparatus will be described.

In the above-described chirped Bragg grating (CBG), when a set value of wavelength dispersion is zero, a length of the entire Bragg grating cannot be set to a sufficient length, and thus a sufficient reflectance cannot be obtained. This significantly affects, for example, a case of Lane #0 in which a grid is set to a zero dispersion wavelength. Similarly, when one of a multiplexing filter on the transmission side and a demultiplexing filter on the reception side compensates for total dispersion, a dispersion value to be given by another one of the demultiplexing filter on the reception side and the multiplexing filter on the transmission side needs to be zero. Similarly, an entire Bragg grating length having a sufficient length cannot be secured, and a sufficient filter reflectance cannot be obtained.

Therefore, the present disclosure solves the above problem by giving a specific dispersion amount in addition to a required dispersion amount for compensating for wavelength dispersion generated in an optical fiber.

FIG. 7 is a diagram for explaining dispersion amounts given to the multiplexing filter on the transmission side and the demultiplexing filter on the reception side in order to compensate for the wavelength dispersion generated in the optical fiber. With respect to a dispersion amount generated for each lane of a WDM signal in the optical fiber, that is, a required dispersion amount to be compensated Df [ps/nm] (Df<0 in FIG. 7), a dispersion amount DTx [ps/nm] (DTx>0 in FIG. 7) given to the transmission side, and a dispersion amount DRx [ps/nm] (DRx<0 in FIG. 7) given to the reception side are set so as to satisfy DTx+Df+DRx=0.

As a result, in both the optical signal processing apparatus included in the transceiver on the transmission side as the wavelength multiplexer and the optical signal processing apparatus included in the transceiver on the reception side as the wavelength demultiplexer, an entire Bragg grating length with a sufficient length can be secured, and a sufficient filter reflectance can be obtained.

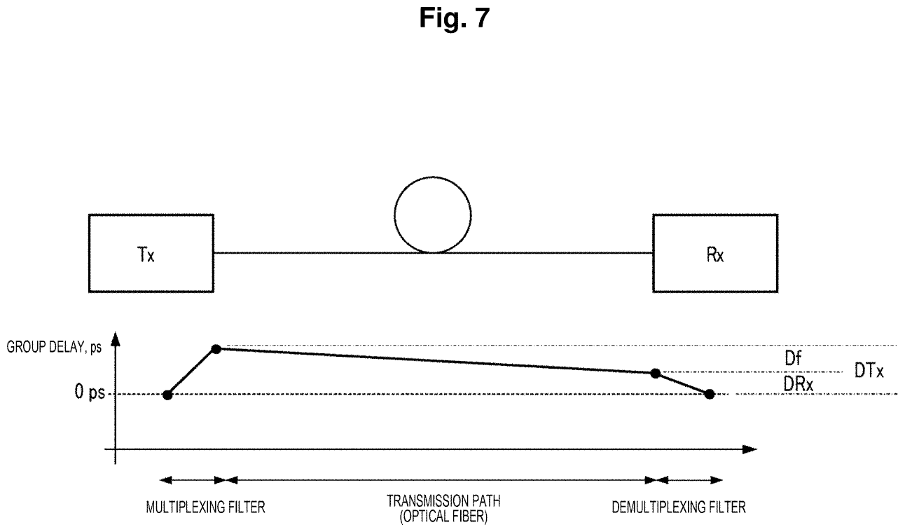

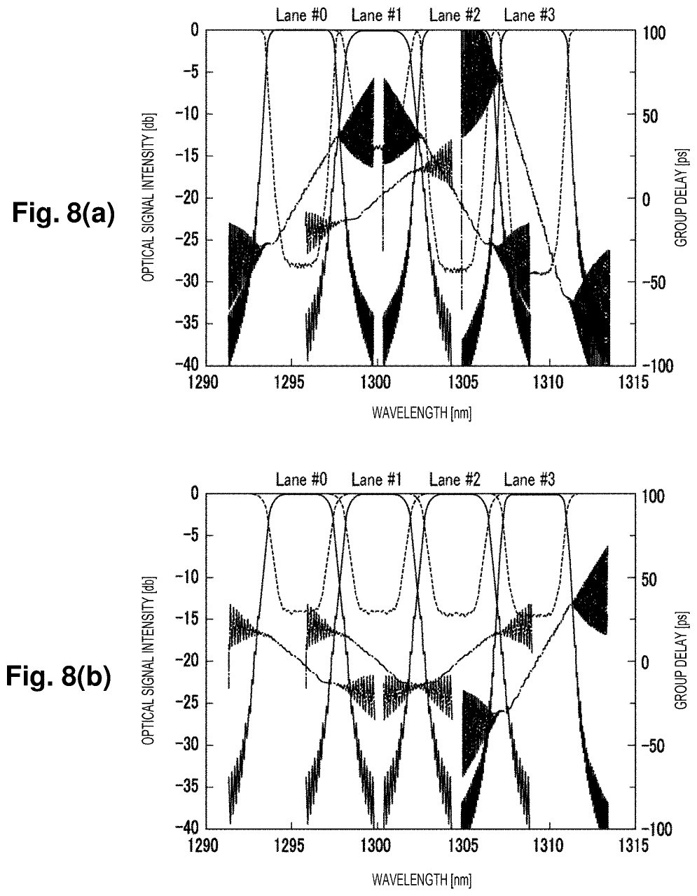

FIGS. 8(a) and 8(b) are a transmission spectrum and a reflection spectrum of a Bragg grating of an optical signal processing apparatus using a quartz-based optical waveguide in the transceiver on the transmission side and the transceiver on the reception side according to the present embodiment, respectively. In graphs illustrated in FIGS. 8(a) and 8(b), a group delay (one-dot chain line) is indicated together with a spectrum of optical signal intensity of reflected light (solid line) and a spectrum of optical signal intensity of transmitted light (broken line).

FIGS. 8(a) and 8(b) illustrate filtering of a LAN-WDM wavelength (800 GHz interval) assuming wavelength multiplexing of four wavelengths used in the Ethernet, and are graphs in consideration of the method of applying the dispersion described above with reference to FIG. 7.

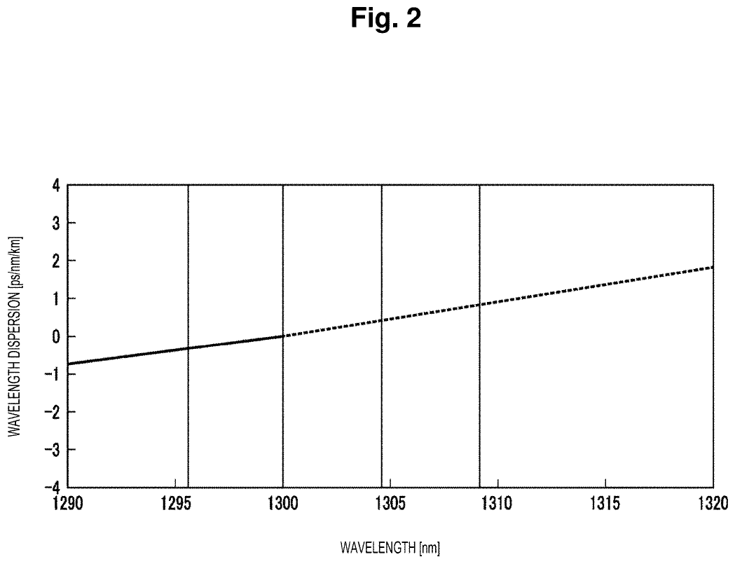

In consideration of FIG. 2, parameters of the Bragg grating are values illustrated in Table 1 below assuming 10 km transmission.

TABLE 1
Parameters of Bragg Grating

| | | Transmission | | Reception | |
|---|---|---|---|---|---|
| Lane # | Parameter | Side | | Side | |
| 0 | Filter Center | 1.29556 | μm | 1.29556 | μm |
| | Wavelength | | | | |
| | Set Group Delay | +8.2 | ps | −4.1 | ps |
| | Diffraction Grating | 6.8 | mm | 6 | mm |
| | Length | | | | |
| 1 | Filter Center | 1.30005 | μm | 1.30005 | μm |
| | Wavelength | | | | |
| | Set Group Delay | +4.1 | ps | −4.1 | ps |
| | Diffraction Grating | 3.4 | mm | 3.4 | mm |
| | Length | | | | |
| 2 | Filter Center | 1.30458 | μm | 1.30458 | μm |
| | Wavelength | | | | |
| | Set Group Delay | −8.2 | ps | +4.1 | ps |
| | Diffraction Grating | 7 | mm | 3.4 | mm |
| | Length | | | | |
| 3 | Filter Center | 1.30914 | μm | 1.30914 | μm |
| | Wavelength | | | | |
| | Set Group Delay | −16.4 | ps | +8.2 | ps |
| | Diffraction Grating | 14 | mm | 7 | mm |

Length

As illustrated in FIGS. 8(a) and 8(b), it can be seen that good transmission characteristics and dispersion characteristics are obtained for each lane.

### Embodiment 5

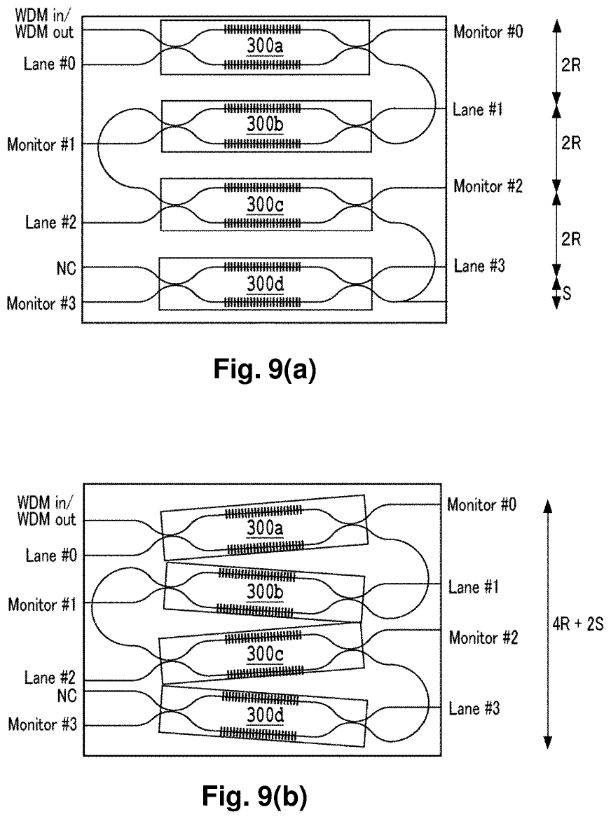

An optical signal processing apparatus according to an embodiment of the present disclosure will be described with reference to FIG. 9. FIGS. 9(a) and 9(b) are diagrams each illustrating a schematic configuration of the optical signal processing apparatus according to the embodiment of the present disclosure. The optical signal processing apparatus of FIGS. 9(a) and 9(b) is different from the optical signal processing apparatus of FIGS. 3A and 3B in layout of the first unit block 300a, the second unit block 300b, the third unit block 300c, and the fourth unit block 300d connected in columns.

In FIG. 9(a), the optical signal processing apparatus has a configuration in which the first unit block 300a, the second unit block 300b, the third unit block 300c, and the fourth unit block 300d are arranged such that a propagation direction of light in an adjacent unit block is changed by 180 degrees. As described above, when the unit blocks are folded back (changed in direction by 180 degrees) and arranged, a footprint of a chip of the entire optical signal processing apparatus can be reduced.

The optical signal processing apparatus illustrated in FIG. 9(b) has a configuration in which the first unit block 300a, the second unit block 300b, the third unit block 300c, and the fourth unit block 300d are arranged such that a propagation direction of light is inverted by more than 180 degrees. In this way, when the unit blocks are folded back and arranged by changing the direction thereof more than 180 degrees, it is possible to further downsize the chip of the entire optical signal processing apparatus.

That is, in a case where the unit blocks are arranged by folding back at 180 degrees as illustrated in FIG. 9(a), size in a vertical direction in FIG. 9(a) is 6R+S with a minimum bending radius of a waveguide as R. Whereas, S is a separation width between two arms of a Mach-Zehnder interferometer. On the other hand, size in a vertical direction in FIG. 9(b) is about 4R+2S. In general, S can be reduced to such an extent that adjacent waveguides are not coupled, whereas R needs to be increased to such an extent that no loss occurs. As an example, R is about 2 mm in a case of a quartz-based optical waveguide having a relative refractive index difference of 1.5%. On the other hand, S is set to about an outer shape of the optical fiber, and thus S=0.125 μm. Therefore, the size in the vertical direction is 12.125 mm in a case of the configuration of FIG. 9(a), whereas it is 8.25 mm in a case of the configuration of FIG. 9(b), and it is possible to reduce the size as compared with FIG. 9(a).

### INDUSTRIAL APPLICABILITY

According to the optical signal processing apparatus of the present disclosure, it is possible to reduce an influence of wavelength dispersion in wavelength division multiplexing communication.

### REFERENCE SIGNS LIST

300 Optical signal processing apparatus
301a Input waveguide
301b Output waveguide
302 Optical branching/merging waveguide
303a, 303b, 303c, 303d, 303e, 303f, 303g, 303h Wavelength selection waveguide
304 Optical branching/merging waveguide
305a, 305b Output waveguide
306 Optical path length adjusting waveguide

1. An optical signal processing apparatus, comprising:
an input waveguide that inputs a wavelength multiplexed signal;
an optical branching waveguide configured to branch the wavelength multiplexed signal from the input waveguide into a plurality of arm waveguides;
a plurality of wavelength selection waveguides connected to the plurality of arm waveguides, each of the plurality of wavelength selection waveguides being configured to select an optical signal from among the branched wavelength multiplexed signals; and
an optical merging waveguide configured to merge light from the plurality of arm waveguides.

2. The optical signal processing apparatus according to claim 1, wherein
at least one of the plurality of arm waveguides includes an optical path length adjusting waveguide.

3. The optical signal processing apparatus according to claim 1, wherein
each of the plurality of wavelength selection waveguides is configured to reflect an optical signal selected from the branched wavelength multiplexed signals and transmit a rest of the branched wavelength multiplexed signals, and
the optical merging waveguide configured to merge light from the plurality of arm waveguides is configured to
merge the reflected optical signals from the plurality of arm waveguides, and
merge the rest of the transmitted wavelength multiplexed signals from the plurality of arm waveguides, and
the optical signal processing apparatus further comprising:
a second input waveguide that inputs the rest of the merged wavelength multiplexed signal as a second wavelength multiplexed signal;
a second optical branching waveguide configured to branch the second wavelength multiplexed signal from the second input waveguide into a plurality of second arm waveguides;
a plurality of second wavelength selection waveguides connected to the plurality of second arm waveguides, each of the second wavelength selection waveguides being configured to select an optical signal from among the branched second wavelength multiplexed signals; and
a second optical merging waveguide configured to merge light from the plurality of second arm waveguides.

4. The optical signal processing apparatus according to claim 3, wherein
each of the plurality of second wavelength selection waveguides is configured to reflect an optical signal selected from the branched second wavelength multiplexed signals and transmit a rest of the branched second wavelength multiplexed signals, and
the second optical merging waveguide configured to merge light from the plurality of second arm waveguides is configured to
merge the reflected optical signals from the plurality of second arm waveguides, and
merge the rest of the transmitted wavelength multiplexed signals from the plurality of second arm waveguides, and
the optical signal processing apparatus further comprising:
a third input waveguide that inputs the light merged by the second optical merging waveguide as a third wavelength multiplexed signal;
a third optical branching waveguide configured to branch the third wavelength multiplexed signal from the third input waveguide into a plurality of third arm waveguides;
a plurality of third wavelength selection waveguides connected to the plurality of third arm waveguides, each of the third wavelength selection waveguides being configured to select an optical signal from among the branched third wavelength multiplexed signals; and
a third optical merging waveguide configured to merge light from the plurality of third arm waveguides.

5. The optical signal processing apparatus according to claim 1, wherein
the wavelength selection waveguide has one or more regions in a light propagation direction,
the wavelength selection waveguide is a waveguide whose width periodically changes,
a period at which the width changes in the one or more regions is different, and
in each of the plurality of regions, a change amount of the width at a start end and a terminal end is smaller than a change amount of the width at a portion other than the start end and the terminal end.

6. An optical signal transmission system comprising a transmission side transponder and a reception side transponder connected by an optical fiber, wherein
the transmission side transponder and the reception side transponder each include the optical signal processing apparatus according to claim 1,
a finite dispersion amount DTx is set in the wavelength selection waveguide included in the transmission side transponder,
a finite dispersion amount DRx is set in the wavelength selection waveguide included in the reception side transponder, and
on condition that a dispersion amount given by the optical fiber is Df, DTx+DRx=Df is satisfied.

7. An optical signal transmission system comprising a transmission side transponder and a reception side transponder connected by an optical fiber, wherein
the transmission side transponder and the reception side transponder each include the optical signal processing apparatus according to claim 2,
a finite dispersion amount DTx is set in the wavelength selection waveguide included in the transmission side transponder,
a finite dispersion amount DRx is set in the wavelength selection waveguide included in the reception side transponder, and
on condition that a dispersion amount given by the optical fiber is Df, DTx+DRx=Df is satisfied.

8. An optical signal transmission system comprising a transmission side transponder and a reception side transponder connected by an optical fiber, wherein
the transmission side transponder and the reception side transponder each include the optical signal processing apparatus according to claim 3,
a finite dispersion amount DTx is set in the wavelength selection waveguide included in the transmission side transponder,
a finite dispersion amount DRx is set in the wavelength selection waveguide included in the reception side transponder, and
on condition that a dispersion amount given by the optical fiber is Df, DTx+DRx=Df is satisfied.

9. An optical signal transmission system comprising a transmission side transponder and a reception side transponder connected by an optical fiber, wherein
the transmission side transponder and the reception side transponder each include the optical signal processing apparatus according to claim 4,
a finite dispersion amount DTx is set in the wavelength selection waveguide included in the transmission side transponder,
a finite dispersion amount DRx is set in the wavelength selection waveguide included in the reception side transponder, and
on condition that a dispersion amount given by the optical fiber is Df, DTx+DRx=Df is satisfied.

10. An optical signal transmission system comprising a transmission side transponder and a reception side transponder connected by an optical fiber, wherein
the transmission side transponder and the reception side transponder each include the optical signal processing apparatus according to claim 5,
a finite dispersion amount DTx is set in the wavelength selection waveguide included in the transmission side transponder,
a finite dispersion amount DRx is set in the wavelength selection waveguide included in the reception side transponder, and
on condition that a dispersion amount given by the optical fiber is Df, DTx+DRx=Df is satisfied.
